(19) United States
(12) Patent Application Publication
(10) Pub. No.: US 2023/0052382 A1
(43) Pub. Date: Feb. 16, 2023

(54) REMOVAL OF EXCESS BUILD MATERIAL FROM A THREE-DIMENSIONAL PRINTED JOB

(71) Applicant: Hewlett-Packard Development Company, L.P., Spring, TX (US)

(72) Inventors: Jorge Diosdado Borrego, Sant Cugat del Valles (ES); David Chanclon Fernandez, Sant Cugat del Valles (ES); Esteve Comas Cespedes, Sant Cugat del Valles (ES)

(21) Appl. No.: 17/793,888

(22) PCT Filed: Apr. 30, 2020
(86) PCT No.: PCT/US2020/030681

§ 371 Date: Jul. 19, 2022

(51) Int. Cl. B29C 64/35; B29C 64/40; B33Y 10/00; B33Y 30/00; B33Y 40/20; B33Y 50/02; B29C 64/393

(52) U.S. Cl. CPC B29C 64/35; B29C 64/40; B33Y 10/00; B33Y 30/00; B33Y 40/20; B33Y 50/02; B29C 64/393

(57) ABSTRACT

A system comprising a support member to support a three-dimensional printed job. The three-dimensional printed job has at least one printed part and associated excess build material. The system further includes a force generating arrangement to impart a force on a three-dimensional printed job supported by the support member; and a build material outlet to allow removal of excess build material from a three-dimensional printed job supported by the support member. The system further includes a sensor to sense a change in the support member, a three-dimensional printed job supported by the support member or a combination thereof wherein the change is due to removal of excess build material from the three-dimensional printed job; and a controller to modify the force imparted on a three-dimensional printed job supported by the support member, wherein the controller modifies the force in dependence upon the change sensed by the sensor.

### BACKGROUND

Additive manufacturing machines produce 3D (three-dimensional) objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into slices each defining that part of a layer or layers of build material to be formed into the object. Build material may be any suitable form of build material, for example fibres, granules or powders. The build material can include a range of materials such as thermoplastic materials, ceramic material and metallic materials. In some additive manufacturing devices, excess build material or cake material may be removed from a 3D printed object by the application of force. As used herein, the term ‘excess build material’ refers to any build material that is deposited during a 3D build job that is not used or consumed to form one or more 3D objects as part of the build job.

### BRIEF DESCRIPTION OF THE DRAWINGS

Some non-limiting examples of the present disclosure will be described in the following with reference to the appended drawings, in which:

FIG. 1 is schematic view of an example of a system that may be used to remove excess build material from a three-dimensional printed job;

FIG. 2 is an example of a method that may remove excess build material from a three-dimensional printed job having at least one printed part and associated excess build material; and

FIG. 3 is an example of a non-transitory computer readable medium coupled to a computing device.

### DETAILED DESCRIPTION

Additive manufacturing systems may utilise build material for the formation of 3D objects. In operation, one or multiple build materials may be deposited on a build surface of an additive manufacturing system and then fused or otherwise bound to form a desired 3D object. Polymers and metals are two such build materials suitable for the formation of a 3D object using an additive manufacturing system. Three-dimensional objects may be mechanically weak following formation and there is a risk that further handling or processing may cause damage or breakage if such processes are not adequately monitored and controlled.

Some additive manufacturing systems form objects by depositing sequential layers of build material and joining portions of each layer post-deposition to form a layer of the desired 3D object. Once the build job is completed, the resulting 3D object may be suspended, supported, enclosed or otherwise surrounded by a volume of excess build material from which it may be separated by a cleaning process. A cleaning process for a 3D object in an additive manufacturing system may involve removal of the build material in which a printed 3D object is suspended or enclosed. The cleaning process may be referred to as ‘de-caking’ as the excess build material cake is removed from around the 3D printed object. When a powdered build material is used, the process may be referred to as ‘de-powdering’. The cleaning process may involve two processes referred to as coarse de-caking, and fine cleaning. In the coarse de-caking process the excess build material or cake may be removed from around the 3D object in bulk. The fine cleaning process may involve a thorough cleaning process where build material not otherwise removed by a bulk cleaning process is removed. Fine cleaning may be carried out using focused air techniques, precision brushes, application of a treatment fluid, ultrasonic methods, and other suitable processes. Examples of material that may be removed by a fine cleaning process includes material adhering to the 3D object or material trapped by the topography of the 3D object.

Coarse de-caking and fine cleaning processes may be performed through the application of force. Force may be applied to: a three-dimensional printed object; a build platform, build chamber or other support member which may support a three-dimensional printed object and excess build material; the build material cake itself; or any combination thereof. The application of force may cause the build material to fluidify such that it will flow out of the build chamber and away from the three-dimensional printed object. Force may be applied using a force generating arrangement. In an example, force applied using a force generating arrangement creates vibrations in the support member or other part of an apparatus in contact with the build material. In this example, the vibration incited in the support member incites the three-dimensional object, excess build material, cake material, or any combination thereof to vibrate. In this example, the force generating arrangement may be a mechanical oscillator or a sonic device. In another example, force may be applied through the use of fluid flows, pressurised fluid or other suitable means. In this example the fluid may be air, nitrogen, argon, a carrier liquid, or any other suitable fluid. In a further example, force may be applied through the use of direct-contact mechanical devices such as brushes, shunts, flaps, presses or other suitable mechanical devices capable of moving build material or inciting build material to flow.

When excess build material or cake material is removed from a three-dimensional printed object during a de-caking process, some of the material that had been previously supporting the 3D object may be removed. In this situation, the three-dimensional object may begin to move as a result of the force applied. In the event that the 3D object is mechanically weak, such movement risks damaging the 3D object. In an example, a moving object may collide with other objects or part of the build unit, build chamber, support member or other apparatus component. Removal of excess build material from a 3D object may result in the depletion of the mass of material supported by a support member as the de-caking and cleaning process progresses. If the force applied to remove excess build material from a 3D object remains constant throughout the cleaning process then it becomes increasingly likely as the mass of remaining build material depletes that the force applied to the 3D object will become sufficient to overcome any friction force that had previously prevented movement of the 3D object. Where vibrational techniques are used, the gradual reduction in the mass subjected to vibration during the process may result in an increase in velocity and acceleration of the 3D printed object over time.

The time to complete a de-caking and cleaning process may depend upon several factors. Such factors may include: the volume of build material cake; the magnitude of the force applied; the means through which force is applied; the geometry of the three-dimensional printed object; the topography of the three-dimensional printed object; the density, particle size, particle shape and associated characteristics of the build material; the rate at which build material may escape the build chamber, support member or other relevant region of the apparatus; or any combination thereof. Consequently, it may be impractical in some situations to determine or predict the optimal duration of a cleaning process as a means to reduce or minimise the risk of part breakage. Reducing the force applied to the 3D object, build material, support member, or any combination thereof may reduce the risk of breakage but may also influence the rate at which excess build material is removed. The capability to control the applied force and modify the force during a cleaning process may further prevent the inadvertent damaging of parts. Control of force and the rate at which excess build material is removed may also allow for further automation of cleaning processes and a reduction in the time required to carry out the associated cleaning processes.

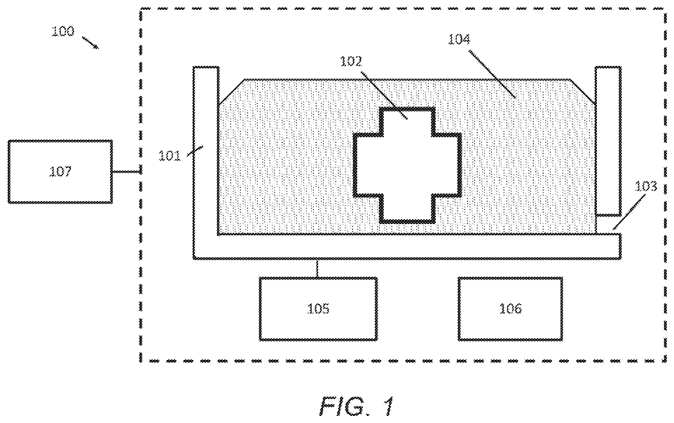

FIG. 1 shows a schematic view of an example system 100 that may be used to remove excess build material from a three-dimensional printed job. System 100 has a support member 101 to support a three-dimensional printed job. The support member 101 may be a build platform, build chamber, build recess, support surface, support structure, or any other suitable component of a build unit or additive manufacturing apparatus. The three-dimensional printed job may have at least one printed three-dimensional part 102 and associated excess build material 104. The excess build material 104 may be any suitable build material usable with an additive manufacturing system including metals or polymers in powdered, granular or fibrous form. The system has a force generating arrangement 105 to impart a force upon the three-dimensional printed job supported by the support member 101. The force generating arrangement may be any arrangement suitable for applying a force to the support member or three-dimensional printed job such as a vibration apparatus, fluid projection device, or a direct-contact mechanical device. In an example, the force generating arrangement 105 imparts a driving force on the support member 101 to move the support member 101 and thereby to provide the force imparted on a three-dimensional printed job supported by the support member 101. In this example, the force generating arrangement modulates the driving force to impart a vibratory movement on the support member at a given frequency. The system 100 further includes a build material outlet 103 to allow removal of build material from the three-dimensional printed job supported by the support member 101. The build material outlet 103 may be an aperture through which excess build material 104 may flow during a cleaning process. In an example, the build material outlet 103 may have one or multiple flaps, doors, valves, or any other suitable actuated gateway to allow the flow of build material to be controlled. In another example, the build material outlet 103 may be an orifice or aperture, or a plurality of apertures in a mesh, without any associated means of closure. The system further has a sensor 106 to sense a change in at least one of the support member 101 and a three-dimensional printed job supported by the support member, wherein the change is due to the removal of excess build material 104 from the three-dimensional printed job. The system further has a controller 107 to modify the force imparted on a three-dimensional printed job supported by the support member 101, wherein the controller 107 modifies the force in dependence upon the change sensed by the sensor 106.

The sensor 106 may sense one or a plurality of properties or characteristics of the support member 101, the three-dimensional printed job, or any combination thereof. In an example, the sensor 106 senses the mass of excess build material 104 being removed. In another example the sensor senses the mass of excess build material 104 and the mass of the support member 101 in combination. In yet another example the sensor 106 senses the mass of the excess build material 104, the support member 101 and a three-dimensional part 102 in combination. In a further example, the sensor 106 senses a vibrational property of the support member 101. In a yet further example, the sensor 106 senses the acceleration or velocity of the support member 101. In an additional example, the sensor 106 senses a vibrational property of the support member 101 in addition to the mass of the support member 101, the excess build material 104, the three-dimensional part 102, or any combination thereof. In a further additional example, the sensor 106 may sense the volume of excess build material remaining in the three-dimensional printed job or support member 101. In examples where the sensor 106 senses mass, the mass may be measured using any suitable mass measurement device. In an example, the mass may be measured using a scale or balance. In another example, the mass may be measuring using a load cell. In further examples, the mass may be measuring using frequency shift or force restoration devices. In examples where the sensor 106 senses a vibrational property, the vibrational property may be measured using a vibration meter, an accelerometer, a vibrational transducer, any other suitable vibrational measurement device, or any combination thereof. In examples where the sensor 106 senses volume, the volume may be measured using optical or acoustic techniques. Sensing a change in the support member 101, a three-dimensional printed job supported by the support member or a combination thereof may therefore be carried out in some examples without directly sensing or measuring mass. Where multiple properties or characteristics are sensed, reference herein to sensor 106 includes reference to more than one sensor wherein a different property or characteristic is sensed by a different sensor.

The controller 107 may modify the force applied to the support member 101 or the three-dimensional printed job 107. The controller 107 may modify the force in dependence upon the change sensed by the sensor 106. In an example where the sensor senses acceleration of the support member 101, the controller 107 modifies the force to maintain or reduce the acceleration or velocity of the support member 101 or printed part of the three-dimensional printed job below a maximum level. In an example, the maximum level of force is one above which a printed part moves relative to a support member. In another example where the maximum level of force is one above which a printed part moves relative to a support member, the sensor continuously senses while the driving force is imparted on the support member. In this example, the controller modifies the force in real time. In another example where the controller modifies the force in real time, the controller maintains acceleration by reducing the frequency of the vibratory movement on the support member. In an example, the controller 107 may increase or decrease the force applied to the support member 101 and the three-dimensional printed job. In another example, the controller 107 may decrease the force applied to the support member 101 and the three-dimensional printed job from a first magnitude to a second reduced magnitude. In another example, the controller 107 may increase and decrease the force applied to the support member and three-dimensional printed job in dependence upon one or a plurality of changes sensed by the sensor 106. In this example, the controller 107 may decrease the force in response to the sensor detecting an increase in acceleration and then subsequently increase the force in response to the sensor detecting a decrease in acceleration in the manner of a closed-loop control system. As used herein in respect of one or multiple forces, the term ‘modify’ means an increase or decrease in the relevant forces without the cessation or complete removal of the force. In an example, reducing the magnitude of a force by 50% would represent a modification of the force. In another example, increasing the magnitude of a force by 5% would represent a modification of the force. Reducing the magnitude of a force by 100% such that the force is no longer applied does not represent a modification within the terms of this disclosure. For the avoidance of doubt, the controller 107 may also cease the application of force in addition to modifying the force as previously described. In an example, the controller will stop the force imparted on a three-dimensional printed job when a pre-determined amount of excess build material has been removed from the three-dimensional printed job. The amount of excess build material to be removed from the three-dimensional printed job may be predetermined by a calculation based upon the amount of build material that will not be consumed to form the one or multiple printed parts of the three-dimensional printed job. The predetermined amount of build material may be a proportion or fraction of the amount of build material that will not be consumed to form the one or multiple printed parts. The predetermined amount of build material may be manually entered via an input device by a user. The predetermined amount of build material may be determined by a computer model of the three-dimensional print job or by an automated calculation performed by a computing component of an additive manufacturing system. Where the predetermined amount of build material is determined by a computer model of the three-dimensional print job or by automated calculation, the predetermined amount of build material may be the amount of build material which, when removed, will cause the three-dimensional printed part or printed parts to move during a cleaning process. The predetermined amount of build material may be determined by an inverse relationship to the mass or volume of build material used to form the printed part or printed parts of the three-dimensional printed job. In another example, the controller may cease the application of force in response to a change sensed by the sensor in combination with one or multiple time periods or time delays.

The controller 107 may be a plurality of components. The controller 107 may be a programmable logic controller (PLC) or other computing device that can carry out instructions. The controller 107 may include one or multiple processing elements that are integrated in a single device or distributed across devices. The controller 107 of the system 100 may have a data input/output interface unit to receive input data from internal or external components or send data to internal or external components. In an example, the controller may have an input device (not shown) to allow a user to interact with the system 100. The controller may also output data to other external components, such as a display unit. The controller 107 may further include a processor to manage all the components within the controller 107. Where present, the processor may process all data flow between the components within the controller 110. The processor may be any of a central processing unit, a semiconductor-based microprocessor, an application specific integrated circuit (ASIC), and/or other device suitable for retrieval and execution of instructions. The controller 107 may further include a storage or memory unit to store any data or instructions which may need to be accessed by, for example, a processor. Where present, the memory unit may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like. In an example, the controller 107 may include a PLC (programmable-logic-controller. In another example, the controller 107 may implement a PID (proportional—integral—derivative) controller. In a further example, the controller 107 may implement a FO (fractional-order) controller. In yet another example, the controller 107 may implement an IO (integer-order) controller. The controller may operate in a closed-loop or an open-loop manner dependent upon the wider functions to be carried out by the controller. The controller may further include a system model. Where the controller includes a system model, the controller may compare the change sensed by the sensor with one or a plurality of parameters of the system model.

In use, the system 100 may include a three-dimensional printed job having excess build material 104 with a three-dimensional part 102 held within the excess build material 104. The excess build material 104 and three-dimensional part 102 may be supported by support member 101. When a user desires to remove the excess build material 104 from the three-dimensional part 102, the support member 101, or the support member 101 and the three-dimensional part 102, the user may operate force generating arrangement 105 to apply a force to the support member 101, the three-dimensional part 102, the excess build material 104, or any combination thereof. The user may operate the force generating arrangement 105 to apply the force by way of an instruction or signal received or issued by the controller 107. An instruction or signal issued by the controller may be received by the force generating arrangement 105 to initiate the application of force. When force is applied to the support member 101, the three-dimensional part 102, the excess build material 104, or any combination thereof, the excess build material 104 may be fluidised and incited to leave the support member 101 by way of build material outlet 103. As build material 104 leaves the support member 101, the mass of the three-dimensional printed job or the three-dimensional printed job in combination with the support unit 101 will decrease. As the excess build material is removed from the three-dimensional print job the mass, and consequently volume, of build material 104 supported by the support member 101 may decrease. The sensor 106 may sense or detect a change in the combination of the support member 101 and the three-dimensional printed job supported by the support member 101 due to the removal of the excess build material 104 from the three-dimensional printed job. When the sensor 106 senses such a change, the controller may modify the force depending upon the change sensed by the sensor. For example, if the sensor senses that the mass of material remaining in the support unit 101 has decreased below a threshold then the controller may reduce the force to prevent movement of the three-dimensional part 102. In this example, the threshold may be calculated at least in part by determining the amount of excess build material which, when removed from the three-dimensional printed job, will cause the printed part or printed parts to move during a cleaning process. The threshold may be a portion or fraction of the excess build material which, when removed, will cause the printed part of printed parts to move. The threshold may be manually entered via an input device by a user. The threshold may be determined by a computer model of the three-dimensional print job or by an automated calculation performed by a computing component of the additive manufacturing system. Where an automated calculation is performed, the automated calculation may be based upon the amount of build material deposited during the three-dimensional printed job, the change detected by the sensor 106, information relating to the three-dimensional printed job entered by the user, information derived from a system model, a calculation of the amount of build material removal which will result in the movement of the printed part or parts, any other suitable information, or any combination thereof. The threshold amount of build material may be determined by an inverse relationship to the mass or volume of build material used to form the printed part or printed parts of the three-dimensional printed job. The threshold may be predetermined prior to the start of a cleaning process. In another example, if the sensor senses that the vibration of the support member exceeds one or multiple threshold characteristics such as velocity or acceleration then the controller may reduce the vibration of the support unit 101 to prevent movement of the three-dimensional part 102 while maintaining flow of excess build material 104 through the build material outlet 103. In an example, a system includes the sensor to sense the mass of excess build material and the controller modifies the force, in dependence upon the mass of build material removed from the three-dimensional printed job, to maintain acceleration of the support member below a maximum level. In this example the system includes a second sensor to sense acceleration of the support member wherein the controller also modifies the force, in dependence upon the acceleration of the support member, to maintain acceleration of the support member below a maximum level.

In one example, the system 100 may find use as part of an additive manufacturing apparatus. In such an example, the system 100 may form part of the additive manufacturing apparatus or be integrated therein. In another example, the system 100 may find use in an apparatus distinct or remote from an additive manufacturing apparatus in which a three-dimensional build job is carried out. In this example, the system 100 may form part of a material handling station, cleaning station, post-processing station, removable build unit or any other suitable apparatus. In other examples, the support member 101 and three-dimensional printed job may be moved from an additive manufacturing apparatus and into an apparatus comprising the system 100.

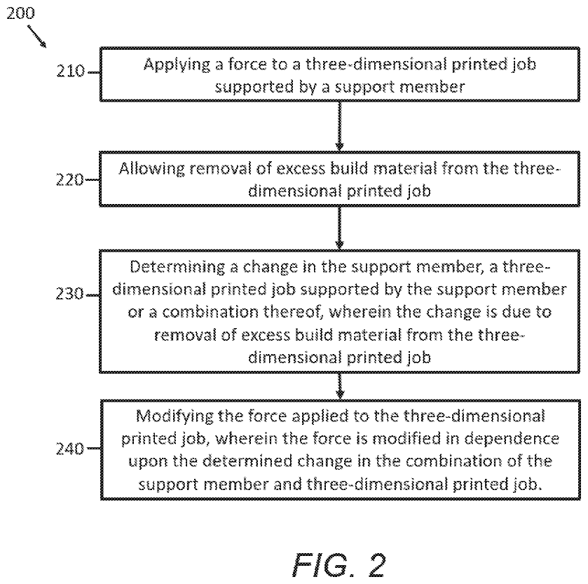

FIG. 2 shows an example of a method 200 that may be used to remove excess build material from a three-dimensional printed job wherein the three-dimensional printed job includes one or multiple printed parts and associated excess build material. The method 200 involves applying 210 a force to a three-dimensional printed job supported by a support member. The force may be applied using any suitable means such as vibrational techniques, the direction or emission of one or multiple fluids, or the use of a direct-contact mechanical device. As described in respect of FIG. 1, the force may be applied using a force generating arrangement 105. The method 200 further involves allowing 220 removal of excess build material from the three-dimensional printed job. Removal of excess build material may occur via build material outlet 103 as shown and previously described in respect of FIG. 1. Allowing 220 removal of excess build material may involve actuating, translating, moving or otherwise operating one or multiple gating devices that may prevent the flow of build material through the build material outlet 103. In an example, allowing 220 removal of excess build material may involve actuating a door from a first position in which it at least partially occludes the build material outlet 103 to a second position in which build material may flow more freely through the build material outlet 103. In another example, allowing 220 removal of excess build material may involve sliding a screen from a configuration in which it obstructs the build material outlet 103 to a configuration in which the build material outlet 103 is free from obstruction. The method further includes determining 230 a change in the combination of the support member 101 and three-dimensional printed job, wherein the change is due to removal of excess build material from the three-dimensional printed job. The determining 230 may be carried out with a sensor as described in respect of system 100 of FIG. 1. The determining 230 may be carried out continuously, continually, intermittently, or in any other suitable manner. In an example, the determining 230 is performed continuously while a force is imparted upon the support member, three dimensional printed job, excess build material or any combination thereof. The determining 230 may occur at any relevant point in a cleaning process during which excess build material is removed from the three-dimensional print job. In one example, the determining 230 may occur after the allowing 220 removal of excess build material has commenced. In another example, the determining 230 may occur before, during, and after the allowing 220 removal of excess build material. The change which is determined may be any change which indicates that the three-dimensional printed part may begin to move relative to the support member or move with increased velocity. For example, the change may be a change in mass, a change in velocity, a change in volume, a change in acceleration, a change in any other suitable parameter, or any combination thereof. In an example, the determined change is a change in mass of excess build material. In another example, the determined change is a change in the acceleration of a support member. The method 200 further involves modifying 240 the force applied to the three-dimensional printed job, wherein the force is modified in dependence upon the determined change in the combination of the support member and three-dimensional printed job 240. As previously described, the modifying 240 may involve an adjustment in the magnitude of the force without removing the force entirely, stopping the force or adjusting the magnitude of the force to zero. In an example, the method further involves modifying the force to maintain the acceleration or velocity of a printed part of the three-dimensional printed job within an acceptable range of acceleration or velocity. In an example, the modifying 240 involves maintaining the acceleration of a three-dimensional printed part below a maximum level. In another example, the modifying 240 involves maintaining the acceleration of the support member below a maximum level. In this example, the maximum level may be the acceleration at which the three-dimensional printed part will move. The dependence of the modifying 240 may, in practice, result in the force being modified to a greater extent when a greater magnitude of change is determined and to a lesser extent when a change of lesser magnitude is determined. In an example, the modifying 240 may be proportional to the magnitude of the determined change. In another example the modifying 240 may be related to the determined change by one or multiple mathematical formulae. In an example where the determining 230 is carried out continuously, the modifying 240 may be carried out in real-time. Where the modifying 240 is carried out in real time, the modifying 240 may be repeated one or multiple times. In another example, the modifying may maintain a constant acceleration, a constant velocity, or a constant displacement of the support member or three-dimensional part. In a yet further example, the modifying 240 maintains a predetermined rate of removal of build material from the three-dimensional printed job. In an additional example, the modifying may adjust the force in fixed increments upon the sensing of a change of any magnitude.

Method 200 may further involve repeating the determining 230 and adjusting 240 one or multiple times. The determining 230 and adjusting 240 may be repeated iteratively. In an example, the determining 230 and adjusting 240 may be repeated until the quantity, volume or mass of excess build material supported by the support member has decreased below a predetermined threshold. In another example, the determining 230 and adjusting 240 may be repeated until substantially all of the excess build material supported by the support member has been removed. In a further example, the determining 230 and adjusting 240 may be repeated until the acceleration or velocity of the support member 101, excess build material 104, printed part, or any combination thereof reaches a predetermined threshold. The method 200 may further involve comparing the change in the combination of the support member and three-dimensional printed job with a system model and ascertaining whether the printed part will move based on the comparison. In this example the dependence of the force modification is based upon, or may take into account, ascertaining whether the printed part will move relative to the support member. If it is ascertained that the printed part may move, the modification may reduce the magnitude of the applied force. In some examples, if it is ascertained that the printed part will not move, the magnitude of force may be maintained constant or increased to facilitate efficient removal of build material. The method 200 may also involve one or multiple additional operations depending on the objectives of a user. For example, the method 200 may involve stopping the application of force. In a further example, the method 200 involves stopping the application of force when a predetermined amount of excess build material is removed from the three-dimensional printed job. In another example, the method may further involve transferring the three-dimensional part to a post-processing unit. In a yet further example, the method 200 may further involve fine cleaning the printed part. In a further additional example, the method 200 may involve treating the three-dimensional part with a treatment fluid.

The method 200 to remove excess build material from a three-dimensional printed job may be wholly, or in part, performed automatically by an additive manufacturing apparatus or related apparatus which includes a system such as system 100 shown and described in FIG. 1. The method 200 may be carried out automatically in response to a user selecting a mode of operation on the additive manufacturing system or related apparatus. In another example, the method 200 may be carried out automatically following the completion of an additive manufacturing process without any input from a user once the additive manufacturing process has been completed. In an example, the applying 210, allowing 220, determining 230 or modifying 240 parts of the method may be performed by the additive manufacturing system or related apparatus without in response to a user selecting a cleaning mode or operation on the additive manufacturing system or related apparatus.

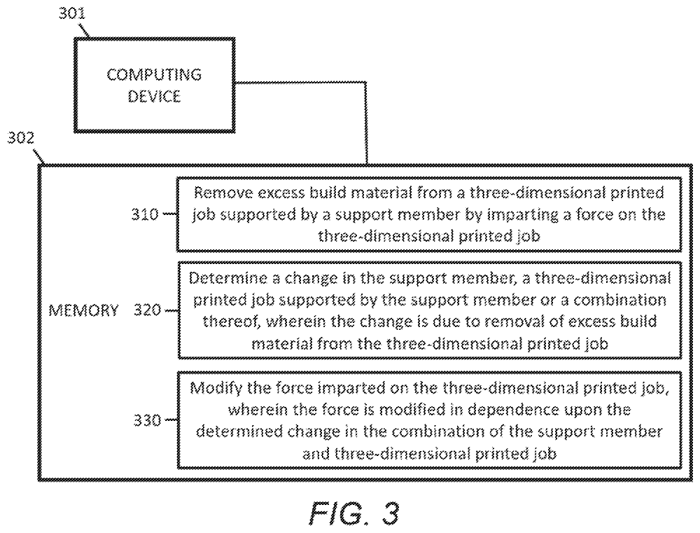

FIG. 3 shows an example of a non-transient computer readable medium comprising instructions which, when executed on a computing device 301, cause the computing device to: remove 310 excess build material from a three-dimensional printed job supported by a support member by imparting a force on the three-dimensional printed job, the three-dimensional printed job having at least one printed part and associated excess build material. When the instructions are executed, the computing device 301 may further determine 320 a change in the combination of the support member and three-dimensional printed job, wherein the change is due to removal of excess build material from the three-dimensional printed job. The computing device 301 may also, when executing instructions, modify 330 the force imparted on the three-dimensional printed job, wherein the force is modified in dependence upon the determined change in the combination of the support member and three-dimensional printed job. The computing device 301 may comprise a processor. The computing device 301 may be communicably coupled to an additive manufacturing system, a post-processing unit, a cleaning unit, a build unit, or any combination thereof. The non-transient computer readable medium may be any electronic magnetic, optical or other physical storage device that stores executable instructions, sometimes referred to as a memory 302. Thus, the non-transient computer readable medium may be, for example, Random Access Memory (RAM), and Electrically-Erasable Programmable Read-Only Memory (EEPROM), a storage drive, an optical disc, and the like. The modify 330 instruction stored by the non-transitory computer-readable medium of claim may cause the computing device to modify the force to maintain acceleration or velocity of a printed part of the three-dimensional printed job below a maximum level.

The processes and methods described herein may be represented by one or multiple mathematical formula. In an example, the three-dimensional printed object will not move following the application of force if the applied force is lower in magnitude than the frictional force between the three-dimensional printed object and the build material, the support member, or any combination thereof. The system may therefore be represented as a system model based upon the following equations:

| | | | |
|---|---|---|---|
| Normal Force | Nᵢ | = mᵢ · g | |
| Shaking Force | Sᵢ(t) | = mᵢ · a(t) | = mᵢ · [A · ω · |
| | | | cos(ω² · t + φ)] |
| Friction Force | F_{fi} | = μ · Nᵢ | = μ · mᵢ · g |

where ‘m’ represents mass in kilograms (kg); ‘g’ represents acceleration due to gravity in meters per second squared (m/s²); ‘a’ represents acceleration in meters per second squared (m/s²); ‘t’ represents time in seconds (s), ‘ω’ represents angular velocity in radians per second (rad/s); ‘A’ represents maximum displacement; ‘φ’represents the phase constant; μ represents the coefficient of friction which is dependent upon the properties of the contacting materials. The mathematical condition at which no sliding or movement of the three-dimensional printed object may occur can therefore be defined as:

F_{fi}≥S_maxᵢ→μ·g≥A·ω²

Extending the above, the dynamic system may therefore be approximated in the following manner:

Fo cos(wt)=(M+m)\ddot{χ}+kχ

where Fo (w,m)=mew²; ‘e’ represents eccentricity in metres (m); ‘m’ represents uncentered mass in kilograms (kg); and ‘w’ represents angular velocity in radians per second (rad/s). For simplicity, the model may be considered in one axis. It may also be assumed that the damping coefficient is equal to 0. In practice, damping may be higher than 0. In some examples, the system and model may operate more effectively at lower values of damping coefficient ‘c’. The solutions to the differential equation may therefore be the following:

$$x ( t ) = \frac{{mrw}^{2}}{K - ( M + m ) {w}^{2}} cos ( wt + θ )$$

$$\dot{x} ( t ) = \frac{- {mrw}^{3}}{K - ( M + m ) {w}^{2}} sin ( wt + θ )$$

$$\ddot{x} ( t ) = \frac{- {mrw}^{4}}{K - ( M + m ) {w}^{2}} cos ( wt + θ )$$

where the natural frequency and the damping factor may be represented as:

$$wn = \sqrt{\frac{k}{M + m}}$$

The system model may form part of the controller. The controller may compare the change sensed by the sensor with one or multiple parameters of the system model. In this example, the controller may determine whether the three-dimensional part will move based upon the change sensed by the sensor and the parameters and equations forming part of the system model.

In operation, a controller may control the system 100 and method 200 through application of the system model. In a first example, the controller may adopt a control strategy where a mass flow is modelled. In this example, the controller may receive mass information from a sensor which includes a load cell. The mass information may be passed to a controller such as a PID controller which provides a signal to the force generating arrangement which causes the force generating arrangement to change the force generated in response to the mass information. In a second example, the controller may receive acceleration or vibration information from a sensor which includes an accelerometer or a vibration detector. The acceleration or vibration information may be passed to a PID controller, bang-bang controller, neural network controller, or any other suitable controller which provides a signal to the force generating arrangement which causes the force generating arrangement to change the force generated in response to the acceleration of vibration information. In a third example, the controller may receive both mass information and acceleration or vibration information. The mass information and acceleration information may be passed to a PID controller which provides a signal to the force generating arrangement which causes the force generating arrangement to change the force generated in response to the mass information, the acceleration or vibration information, or both the mass information and the acceleration or vibration information. In each of the first, second and third examples, the controller may include a system model component which may apply one or multiple mathematical formulae or system representations to determine whether the three-dimensional part exceeds, or will exceed, a predetermined threshold of velocity or acceleration. In the third example, the mass information may be collected at the same time as the acceleration or vibration information. In the third example, the mass information may be passed to the PID controller at the same time, at a time proximate, or at a different time than the acceleration or vibration information. The collection of mass information and acceleration or vibration information may allow the controller to verify or validate other information processed by the controller.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. A system comprising a support member to support a three-dimensional printed job, the three-dimensional printed job having at least one printed part and associated excess build material; a force generating arrangement to impart a force on a three-dimensional printed job supported by the support member; and a build material outlet to allow removal of excess build material from a three-dimensional printed job supported by the support member;
the system further comprising a sensor to sense a change in the support member, a three-dimensional printed job supported by the support member or a combination thereof wherein the change is due to removal of excess build material from the three-dimensional printed job; and
a controller to modify the force imparted on a three-dimensional printed job supported by the support member, wherein the controller modifies the force in dependence upon the change sensed by the sensor.

2. The system of claim 1, wherein the sensor senses mass of excess build material.

3. The system of claim 1, wherein the sensor senses acceleration of the support member.

4. The system of claim 1, wherein the controller modifies the force imparted on a three-dimensional printed job to provide a predetermined rate of removal of excess build material from the three-dimensional printed job.

5. The system of claim 1, wherein the controller stops the force imparted on a three-dimensional printed job when a predetermined amount of excess build material has been removed from the three-dimensional printed job.

6. The system of claim 1, wherein the force generating arrangement imparts a driving force on the support member to move the support member and thereby to provide the force imparted on a three-dimensional printed job supported by the support member, and wherein the force generating arrangement is modulates the driving force to impart a vibratory movement on the support member at a given frequency.

7. The system of claim 6, wherein the sensor senses acceleration of the support member and the controller modifies the force to maintain acceleration of the support member below a maximum level.

8. The system of claim 7, wherein the maximum level of acceleration of the support member is one above which a printed part moves relative to the support member.

9. The system of claim 8, wherein the sensor continuously senses while the driving force is imparted on the support member and the controller modifies the force in real time.

10. The system of claim 9, wherein controller modifies the force to maintain acceleration by reducing the frequency of the vibratory movement on the support member.

11. The system of claim 6, wherein the sensor senses the mass of excess build material and the controller modifies the force, in dependence upon the mass of excess build material removed from the three-dimensional printed job, to maintain acceleration of the support member below a maximum level; the system comprising a second sensor which senses acceleration of the support member wherein the controller further modifies the force, in dependence upon the acceleration of the support member, to maintain acceleration of the support member below a maximum level.

12. A method to remove excess build material from a three-dimensional printed job having at least one printed part and associated excess build material, the method comprising:
applying a force to a three-dimensional printed job supported by the support member;
allowing removal of excess build material from the three-dimensional printed job;
determining a change in the support member, a three-dimensional printed job supported by the support member or a combination thereof, wherein the change is due to removal of excess build material from the three-dimensional printed job; and
modifying the force applied to the three-dimensional printed job, wherein the force is modified in dependence upon the determined change in the support member, three-dimensional printed job or combination thereof.

13. The method of claim 12, wherein the force is modified to maintain acceleration of a printed part of the three-dimensional printed job within an acceptable range of accelerations.

14. A non-transitory computer-readable medium comprising instructions, which when executed on a computing device, cause the computing device to:
remove excess build material from a three-dimensional printed job supported by a support member by imparting a force on the three-dimensional printed job, the three-dimensional printed job having at least one printed part and associated excess build material;
determine a change in the support member, a three-dimensional printed job supported by the support member or a combination thereof, wherein the change is due to removal of excess build material from the three-dimensional printed job; and
modify the force imparted on the three-dimensional printed job, wherein the force is modified in dependence upon the determined change in the support member, three-dimensional printed job or combination thereof.

15. The non-transitory computer-readable medium of claim 14, wherein the force is modified to maintain acceleration of a printed part of the three-dimensional printed job below a maximum level.
